(19) United States
(12) Patent Application Publication
(10) Pub. No.: US 2013/0321427 A1
(43) Pub. Date: Dec. 5, 2013

(54) COMPUTING DEVICE AND METHOD FOR GENERATING DRAWING CODES OF PICTURES

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: Chung-I Lee, New Taipei (TW); Hai-Hong Lin, Shenzhen (CN); De-Yi Xie, Shenzhen (CN); Hai-Yun Chen, Shenzhen (CN); Hai-Tao Tong, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/899,661

(22) Filed: May 22, 2013

(30) Foreign Application Priority Data
May 29, 2012 (CN) 2012101702197

(51) Int. Cl. G06T 11/20

(52) U.S. Cl. CPC G06T 11/20
USPC 345/441

(57) ABSTRACT

In a method for generating drawing codes of a picture being drawn, a plurality of drawing elements and a drawing model for each of the drawing elements are defined. Each drawing model includes one or more drawing parameters. When a drawing element is selected and used to draw a picture, parameter values of the selected drawing element are obtained.

Drawing parameters of a drawing model of the selected drawing element are replaced by the parameter values of the selected drawing element, to obtain drawing codes corresponding to the selected drawing element. According to a sequence of drawing steps of the picture, drawing codes corresponding to each selected drawing element are integrated into the overall drawing codes of the picture.

### BACKGROUND

1. Technical Field

The embodiments of the present disclosure relate to drawing systems and methods, and particularly to a computing device and a method for generating drawing codes of pictures.

2. Description of Related Art

Many graphics applications are provided for users to draw pictures. However, the graphics applications can only generate pictures for display, and cannot generate drawing codes. Sometimes it is not convenient to perform further processes on the pictures without the drawing codes.

### BRIEF DESCRIPTION OF THE DRAWINGS

FIG. 1 is a block diagram of one embodiment of a computing device.

FIG. 2 is a block diagram of one embodiment of function modules of a code generation system in FIG. 1.

FIG. 3 is a flowchart of one embodiment of a method for generating drawing codes of pictures using the computing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives.

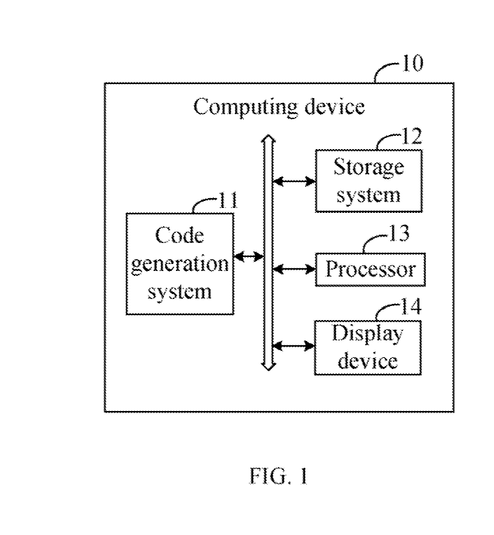

FIG. 1 is a block diagram of one embodiment of a computing device 10. In the embodiment, the computing device 10 includes a code generation system 11, a storage system 12, at least one processor 13, and a display device 14. The code generation system 11 generates drawing codes of a picture when a user is drawing the picture. The storage system 12 may be a dedicated memory, such as EPROM, a hard disk driver (HDD), or flash memory. In some embodiments, the storage system 12 may also be an external storage device, such as an external hard disk, a storage card, or other data storage medium.

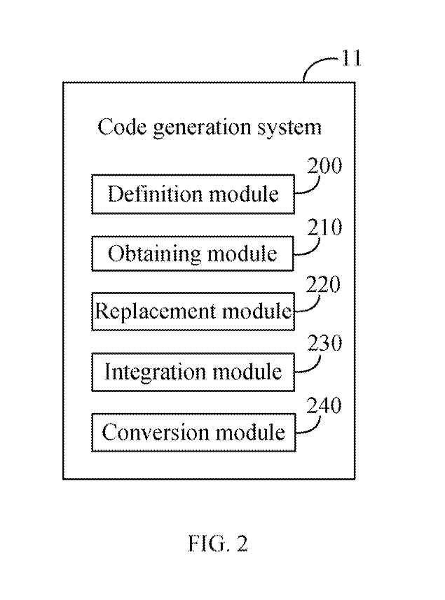

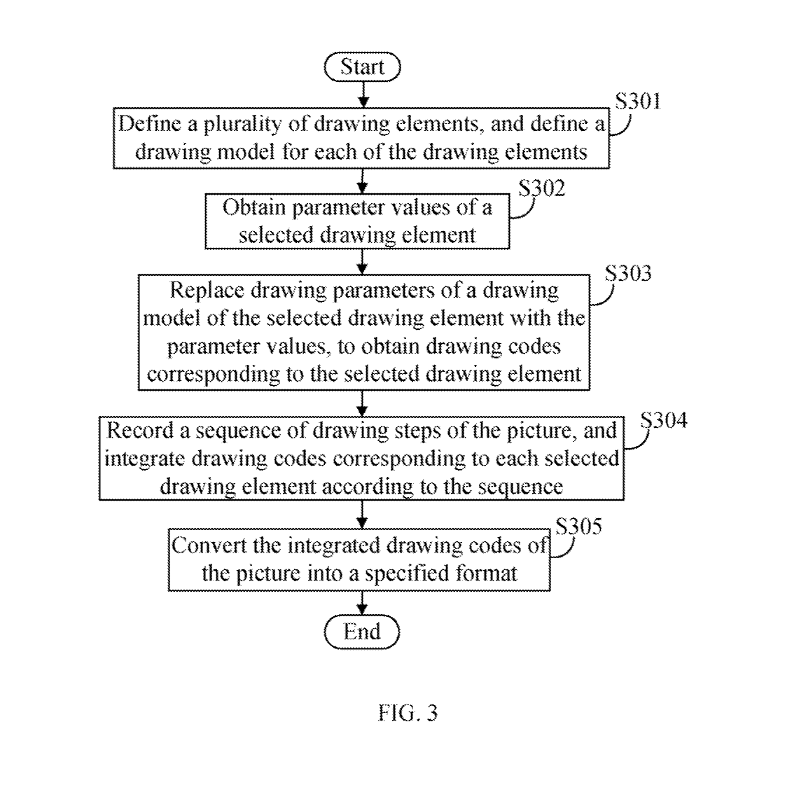

FIG. 2 is a block diagram of one embodiment of function modules of the code generation system 11 in FIG. 1. The code generation system 11 includes a definition module 200, an obtaining module 210, a replacement module 220, an integration module 230, and a conversion module 240. The modules 200-240 may comprise computerized code in the form of one or more programs that are stored in the storage system 12. The computerized code includes instructions that are executed by the at least one processor 13, to provide the aforementioned functions of the code generation system 11. A description of the functions of the modules 200-240 is given below in reference to FIG. 3.

FIG. 3 is a flowchart of one embodiment of a method for generating drawing codes using the computing device 10 in FIG. 1. Depending on the embodiment, additional steps may be added, others removed, and the ordering of the steps may be changed.

In step S301, the definition module 200 defines a plurality of drawing elements, and defines a drawing model for each of the drawing elements. The drawing elements may include shape elements, e.g. a rectangle element and a circle element, to draw different shapes in pictures. The drawing elements may further include operation elements, e.g. a rotation element and a zoom element, to operate on the shapes in pictures. In one embodiment, each drawing element may be represented by an icon, which is displayed on a user interface when pictures are being drawn. Each drawing model consists of a block of program codes and includes one or more drawing parameters. In one example, a drawing model of a line element may include coordinates of a start point and coordinates of an end point. In another example, a drawing model of a circle element may include coordinates of a center, a radius, a start angle, an end angle of the circle, and a formation direction (clockwise or counter-clockwise).

When a user selects one of the drawing elements to draw a picture, in step S302, the obtaining module 210 obtains parameter values of the selected drawing element. For example, a line element is selected by the user to draw a line in a picture. Coordinates of a start point of the line are (1, 1). Coordinates of an end point of the line are (5, 6).

In step S303, the replacement module 220 replaces drawing parameters of a drawing model of the selected drawing element with the parameter values, to obtain drawing codes corresponding to the selected drawing element. For example, a line element is selected by the user to draw a line in a picture. Coordinates of a start point of the line are (1, 1). Coordinates of an end point of the line are (5, 6). Therefore, coordinates of a start point of a drawing model of a line element is replaced by (1, 1), and coordinates of an end point of the drawing model of a line element is replaced by (5, 6), to obtain drawing codes corresponding to the selected line element.

In step S304, the integration module 230 records a sequence of drawing steps of the picture, integrates drawing codes corresponding to each selected drawing element according to the sequence, and stores the integrated drawing codes into the storage system 12. In one example, the user draws a line, a rectangle, and a circle in sequence. The integration module 230 integrates drawing codes corresponding to the line, drawing codes corresponding to the rectangle, and drawing codes corresponding to the circle to generate overall drawing codes of the picture. In one embodiment, the integration module 230 further displays the integrated drawing codes of the picture on the display device 14.

In step S305, the conversion module 240 converts the integrated drawing codes of the picture into a specified format, and stores the integrated drawing codes in the specified format into the storage system 12. In this way, the picture is able to be displayed in a specified environment (e.g., on a webpage). In one embodiment, the conversion module 240 adds tags (e.g., HTML tags) to the integrated drawing codes. In accordance with the integrated drawing codes and the tags, the picture can be displayed on a webpage.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method for generating drawing codes of pictures executed by a processor of a computing device, the method comprising:
defining a plurality of drawing elements, and defining a drawing model for each of the drawing element, each drawing model comprising one or more drawing parameters;
in response that one of the drawing elements is selected and used to draw a picture, obtaining parameter values of the selected drawing element;
obtaining drawing codes corresponding to the selected drawing element by replacing drawing parameters of a drawing model of the selected drawing element with the parameter values of the selected drawing element; and
recording a sequence of drawing steps of the picture, integrating drawing codes corresponding to each selected drawing element according to the sequence, and storing the integrated drawing codes into a storage system of the computing device.

2. The method of claim 1, further comprising:
converting the integrated drawing codes of the picture into a specified format.

3. The method of claim 2, wherein the integrated drawing codes of the picture are converted into the specified format by adding tags to the integrated drawing codes.

4. The method of claim 1, wherein the drawing elements comprise shape elements and operation elements.

5. A computing device, comprising:
at least one processor; and
a storage system storing a plurality of instructions, which when executed by the at least one processor, cause the at least one processor to:
define a plurality of drawing elements, and define a drawing model for each of the drawing element, each drawing model comprising one or more drawing parameters;
in response that one of the drawing elements is selected and used to draw a picture, obtain parameter values of the selected drawing element;
obtain drawing codes corresponding to the selected drawing element by replacing drawing parameters of a drawing model of the selected drawing element with the parameter values of the selected drawing element; and
record a sequence of drawing steps of the picture, integrate drawing codes corresponding to each selected drawing element according to the sequence, and store the integrated drawing codes into the storage system.

6. The computing device of claim 5, wherein the storage system further stores instructions which cause the at least one processor to:
convert the integrated drawing codes of the picture into a specified format.

7. The computing device of claim 6, wherein the integrated drawing codes of the picture are converted into the specified format by adding tags to the integrated drawing codes.

8. The computing device of claim 5, wherein the drawing elements comprise shape elements and operation elements.

9. A non-transitory computer-readable storage medium storing a set of instructions, the set of instructions capable of being executed by a processor of a computing device to implement a method for generating drawing codes of pictures, the method comprising:
defining a plurality of drawing elements, and defining a drawing model for each of the drawing element, each drawing model comprising one or more drawing parameters;
in response that one of the drawing elements is selected and used to draw a picture, obtaining parameter values of the selected drawing element;
obtaining drawing codes corresponding to the selected drawing element by replacing drawing parameters of a drawing model of the selected drawing element with the parameter values of the selected drawing element; and
recording a sequence of drawing steps of the picture, integrating drawing codes corresponding to each selected drawing element according to the sequence, and storing the integrated drawing codes into a storage system of the computing device.

10. The storage medium of claim 9, wherein the method further comprises:
converting the integrated drawing codes of the picture into a specified format.

11. The storage medium of claim 10, wherein the integrated drawing codes of the picture are converted into the specified format by adding tags to the integrated drawing codes.

12. The storage medium of claim 9, wherein the drawing elements comprise shape elements and operation elements.
